(19) United States
(12) Patent Application Publication
(10) Pub. No.: US 2022/0136295 A1
(43) Pub. Date: May 5, 2022

(54) Door Locking Assembly

(71) Applicant: Mark Gizas, Moorcraft, WY (US)

(72) Inventor: Mark Gizas, Moorcraft, WY (US)

(21) Appl. No.: 17/089,774

(22) Filed: Nov. 5, 2020

(51) Int. Cl. E05C 19/00

(52) U.S. Cl. CPC E05C 19/003

(57) ABSTRACT

A door locking assembly for locking a door from the inside includes a brace that has a pair of slots each integrated therein such that a respective one of the slots can be positioned on a neck of a doorknob. The brace is longitudinally elongated to extend between a door on which the doorknob is positioned and an adjacent door jamb. A pair of fingers is each coupled to and extends away from the brace. Each of the fingers extends along a line oriented perpendicular to the brace. In this way each of the fingers extends between the door and the door jamb thereby inhibiting the brace from spinning downwardly on the doorknob.

### CROSS-REFERENCE TO RELATED APPLICATIONS

Not Applicable

### STATEMENT REGARDING FEDERALLY SPONSORED RESEARCH OR DEVELOPMENT Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to locking devices and more particularly pertains to a new locking device for locking a door that could otherwise be unlocked with a master key.

### (2) Description of Related Art Including Information Disclosed Under 37 CFR 1.97 and 1.98

The prior art relates to locking devices including a yoke that includes a pair of slots for engaging a neck on a pair of doorknobs on a double door for locking the double door. The prior art discloses a door jamb lock that engages a neck of a door knob and a doorjamb for locking a door. The prior art discloses a door lock yoke that engages a neck of a doorknob and pin that extends through the door lock yoke to engage a door jamb. The prior art discloses a door jamb lock that is mountable to a door and which includes a pivotable arm that can engage a doorjamb. The prior art also discloses a door lock that includes a pair of flanges that each has a slot integrated therein for engaging a neck of a doorknob.

### BRIEF SUMMARY OF THE INVENTION

An embodiment of the disclosure meets the needs presented above by generally comprising a brace that has a pair of slots each integrated therein such that a respective one of the slots can be positioned on a neck of a doorknob. The brace is longitudinally elongated to extend between a door on which the doorknob is positioned and an adjacent door jamb. A pair of fingers is each coupled to and extends away from the brace. Each of the fingers extends along a line oriented perpendicular to the brace. In this way each of the fingers extends between the door and the door jamb thereby inhibiting the brace from spinning downwardly on the doorknob.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a door locking assembly according to an embodiment of the disclosure.

FIG. 2 is a front view of an embodiment of the disclosure.

FIG. 3 is a right side view of an embodiment of the disclosure.

FIG. 4 is a top view of an embodiment of the disclosure.

FIG. 5 is a perspective in-use view of an embodiment of the disclosure.

### DETAILED DESCRIPTION OF THE INVENTION

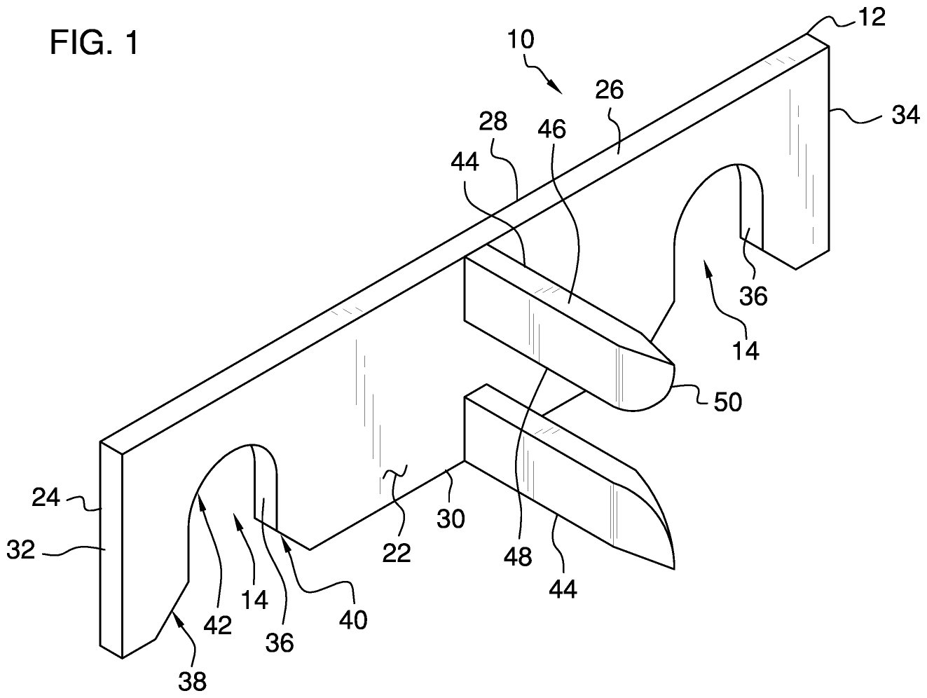

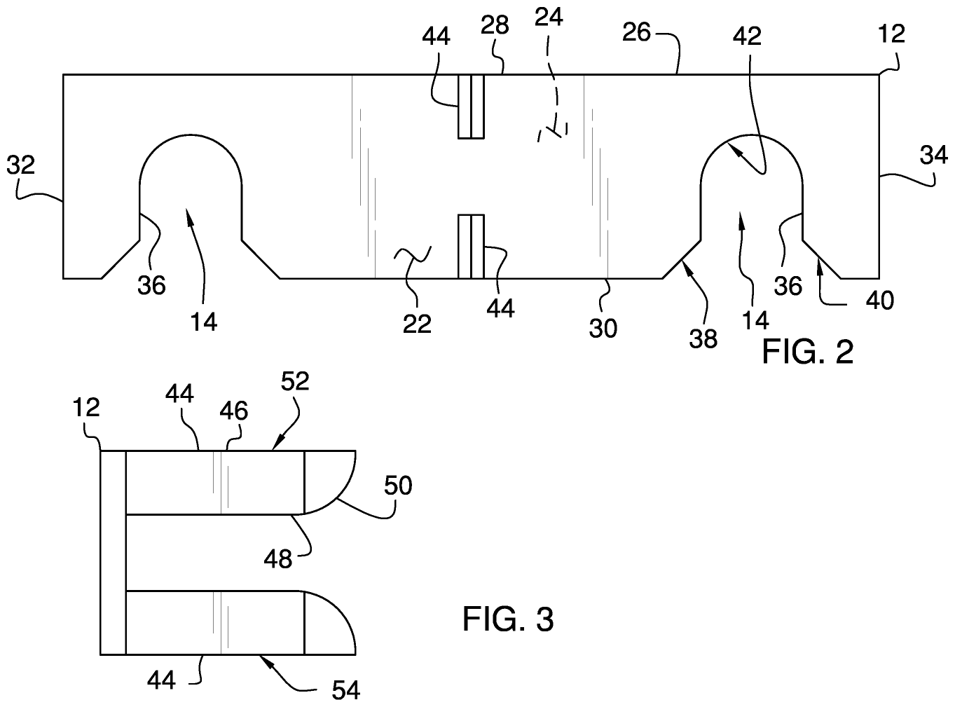

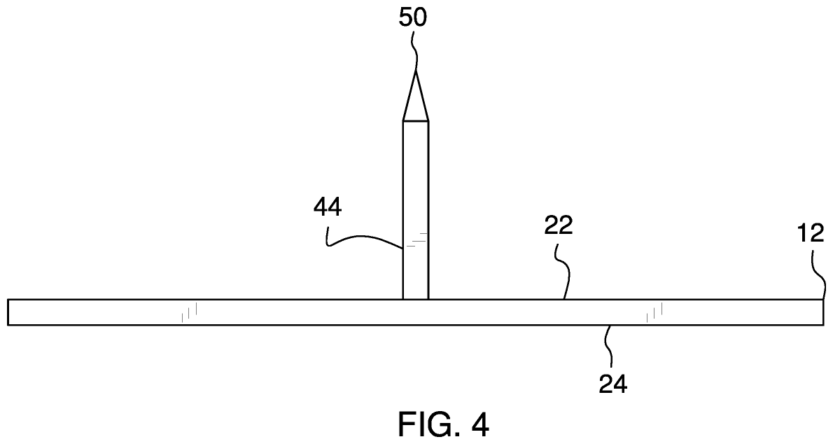

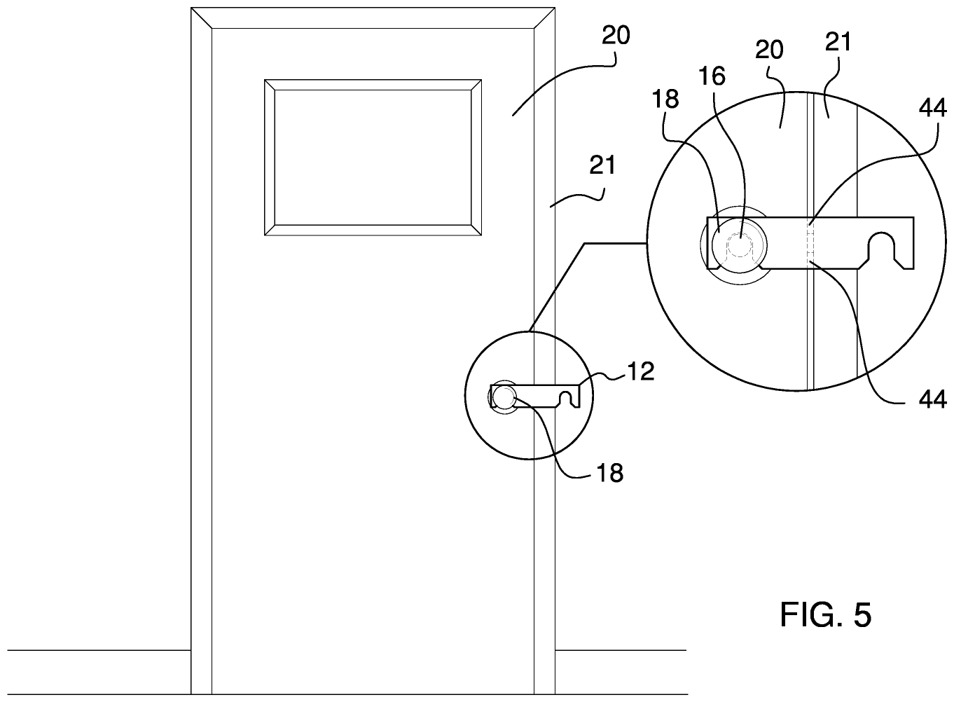

With reference now to the drawings, and in particular to FIGS. 1 through 5 thereof, a new locking device embodying the principles and concepts of an embodiment of the disclosure and generally designated by the reference numeral 10 will be described.

As best illustrated in FIGS. 1 through 5, the door locking assembly 10 generally comprises a brace 12 that has a pair of slots 14 integrated therein. A respective one of the slots 14 can be positioned on a neck 16 of a doorknob 18. Additionally, the brace 12 is longitudinally elongated such that the brace 12 extends between a door 20 on which the doorknob 18 is positioned and an adjacent doorjamb 21. The door 20 may be a door in a classroom of a public school or other type of door in an institutional environment that can be unlocked with a master key. Moreover, the brace 12 is comprised of a rigid material to inhibit the door 20 from being opened when the brace 12 is positioned on neck 16 of the doorknob 18. In this way a teacher, for example, can quickly lock the door 20 from inside of a classroom thereby inhibiting an intruder from unlocking the door 20 with a master key.

The brace 12 has a front surface 22, a back surface 24 and a perimeter edge 26 extending therebetween, and the perimeter edge 26 has a top side 28, a bottom side 30, a first lateral side 32 and a second lateral side 34. The brace 12 is elongated between the first lateral side 32 and the second lateral side 34. Each of the slots 14 extends through the front surface 22 and the back surface 24, and each of the slots 14 extends from the bottom side 30 toward the top side 28. Moreover, each of the slots 14 is positioned adjacent to a respective one of the first lateral side 32 and the second lateral side 34.

Each of the slots 14 has a bounding edge 36 and the bounding edge 36 of each of the slots 14 has a first section 38, a second section 40 and a third section 42. Each of the first section 38 and the second section 40 associated with each of the slots 14 angles outwardly from a centerline of the associated slot 14. Additionally, the third section 42 of each of the slots 14 curves between the first section 38 and the second section 40. In this way the third section 42 of a respective one of the slots 14 can conform to curvature of the neck 16 of the doorknob 18 when the respective slot 14 is positioned on the neck 16 of the doorknob 18. Additionally, the pair of slots 14 facilitates the brace 12 to be positioned on either a left swing door or a right swing door.

A pair of fingers 44 is each coupled to and extends away from the brace 12. Each of the fingers 44 extends along a line that is oriented perpendicular to a longitudinal axis of the brace 12. In this way each of the fingers 44 can extend between the door 20 and the doorjamb 21 thereby inhibiting the brace 12 from spinning downwardly on the doorknob 18. Each of the fingers 44 extends away from the front surface 22 of the brace 12. Each of the fingers 44 has an upper edge 46, a lower edge 48 and a distal end 50 with respect to the front surface 22.

Each of the fingers 44 is spaced apart from each other and is distributed along a centerline of the brace 12 that extends between the top side 28 and the bottom side 30 of the perimeter edge 26 of the brace 12. Moreover, each of the fingers 44 tapers to a point at the distal end 50 for enhancing inserting the fingers between the door 20 and the doorjamb 21. The pair of fingers 44 includes a first finger 52 and a second finger 54. The distal end 50 of the first finger 52 curves upwardly between the lower edge 48 and the upper edge 46 of the first finger 52. Additionally, the distal end 50 of the second finger 54 curves downwardly between the upper edge 46 and the lower edge 48 of the second finger 54.

In use, the brace 12 is positioned on the neck 16 of the doorknob 18 such that each of the fingers 44 extends between the door 20 and the doorjamb 21. In this way the brace 12 is retained in a horizontal orientation between the door 20 and the doorjamb 21. Thus, the door 20 is inhibited from being opened from the outside. In this way an intruder that may have gained access to a master key is inhibited from unlocking the door 20 and entering the room associated with the door 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A door locking assembly for inhibiting a door from being opened from outside of a room, said assembly comprising:
a brace having a pair of slots each being integrated therein wherein a respective one of said slots is configured to be positioned on a neck of a doorknob, said brace being longitudinally elongated wherein said brace is configured to extend between a door on which the doorknob is positioned and an adjacent door jamb, said brace being comprised of a rigid material wherein said brace is configured to inhibit the door from being opened when said brace is positioned on neck of the door knob; and
a pair of fingers, each of said fingers being coupled to and extending away from said brace, each of said fingers extending along a line being oriented perpendicular to a longitudinal axis of said brace wherein each of said fingers is configured to extend between the door and the door jamb thereby inhibiting said brace from spinning downwardly on the doorknob.

2. The assembly according to claim 1, wherein said brace has a front surface, a back surface and a perimeter edge extending therebetween, said perimeter edge having a top side, a bottom side, a first lateral side and a second lateral side, said brace being elongated between said first lateral side and said second lateral side, each of said slots extending through said front surface and said back surface, each of said slots extending from said bottom side toward said top side, each of said slots being positioned adjacent to a respective one of said first lateral side and said second lateral side.

3. The assembly according to claim 2, wherein each of said slots has a bounding edge, said bounding edge of each of said slots having a first section, a second section and a third section, each of said first section and said second section associated with each of said slots angling outwardly from a centerline of said associated slot, said third section of each of said slots curving between said first section and said second section wherein said third section of a respective one of said slots is configured to conform to curvature of the neck of the doorknob when said respective slot is positioned on the neck of the doorknob.

4. The assembly according to claim 2, wherein each of said fingers extends away from said front surface of said brace, each of said fingers having an upper edge, a lower edge and a distal end with respect to said front surface, each of said fingers being spaced apart from each other and being distributed along a centerline of said brace that extends between said top side and said bottom side of said perimeter edge of said brace.

5. The assembly according to claim 4, wherein said pair of fingers includes a first finger and a second finger, said distal end of said first finger curving upwardly between said lower edge and said upper edge of said first finger, said distal end of said second finger curving downwardly between said upper edge and said lower edge of said second finger.

6. A door locking assembly for inhibiting a door from being opened from outside of a room, said assembly comprising:
a brace having a pair of slots each being integrated therein wherein a respective one of said slots is configured to be positioned on a neck of a doorknob, said brace being longitudinally elongated wherein said brace is configured to extend between a door on which the doorknob is positioned and an adjacent door jamb, said brace being comprised of a rigid material wherein said brace is configured to inhibit the door from being opened when said brace is positioned on neck of the door knob, said brace having a front surface, a back surface and a perimeter edge extending therebetween, said perimeter edge having a top side, a bottom side, a first lateral side and a second lateral side, said brace being elongated between said first lateral side and said second lateral side, each of said slots extending through said front surface and said back surface, each of said slots extending from said bottom side toward said top side, each of said slots being positioned adjacent to a respective one of said first lateral side and said second lateral side, each of said slots having a bounding edge, said bounding edge of each of said slots having a first section, a second section and a third section, each of said first section and said second section associated with each of said slots angling outwardly from a centerline of said associated slot, said third section of each of said slots curving between said first section and said second section wherein said third section of a respective one of said slots is configured to conform to curvature of the neck of the doorknob when said respective slot is positioned on the neck of the doorknob; and
a pair of fingers, each of said fingers being coupled to and extending away from said brace, each of said fingers extending along a line being oriented perpendicular to a longitudinal axis of said brace wherein each of said fingers is configured to extend between the door and the door jamb thereby inhibiting said brace from spinning downwardly on the doorknob, each of said fingers extending away from said front surface of said brace, each of said fingers having an upper edge, a lower edge and a distal end with respect to said front surface, each of said fingers being spaced apart from each other and being distributed along a centerline of said brace that extends between said top side and said bottom side of said perimeter edge of said brace, said pair of fingers including a first finger and a second finger, said distal end of said first finger curving upwardly between said lower edge and said upper edge of said first finger, said distal end of said second finger curving downwardly between said upper edge and said lower edge of said second finger.
